(19) United States
(12) Patent Application Publication
(10) Pub. No.: US 2003/0232130 A1
(43) Pub. Date: Dec. 18, 2003

(54) Method of making magnetically attractive coatings

(75) Inventor: David B. Lytle, Cabot, PA (US)

Correspondence Address: Julie W. Meder, 700 Koppers Building, 436 Seventh Avenue, Pittsburgh, PA, 15219-1818, US

(73) Assignee: David B. Lytle Products, Inc.

(21) Appl. No.: 10/172,933

(22) Filed: Jun. 17, 2002

(51) Int. Cl. B05D 5/12; B05D 1/36

(52) U.S. Cl. 427/128; 427/402

(57) ABSTRACT

A magnetically attractive coating composition containing paint and iron particles at a concentration of 70 to 85 wt. %. The paint may be a primer paint. The iron particles are mixed into the paint without stabilizing additives and applied to a surface. The magnetically attractive coating may be covered by a decorative paint or wallpaper.

### BACKGROUND OF THE INVENTION

1. Field of the Invention

The present invention relates to a method of making a magnetically attractive coating composition, more particularly, to a method of producing magnetically attractive surfaces.

2. Prior Art

Typical magnetically attractive surfaces found in homes and businesses include refrigerators, filing cabinets, and other appliances or furnishings manufactured from iron alloys. Small magnets with various indicia, decorative patterns, or other items attached to the magnets are placed against the surface for viewing as movable, temporary displays. While use of magnets in displays in other locations in a home or business may be desirable, magnetically attractive surfaces (those containing an iron alloy) are generally not present throughout such buildings. To overcome this barrier, a sheet of magnetically attractive material, often mounted in a frame and referred to as a magnet board, may be attached to a wall or other surface. Magnetic objects can then be mounted magnetically to the magnetic sheet. Nevertheless, this route to obtaining a magnetic surface (mounting a magnet board) is limiting in its use.

One alternative to mounting a magnet board to a surface is to paint a surface with a magnetically attractive coating composition. One such coating composition is described in U.S. Pat. No. 3,503,882 to Fitch. The composition described therein includes iron powder (in an amount of 75-85 wt. %) and resin along with additives of polyethylene wax, and an alkyl ammonium bentonite with optional colorants all dispersed in the solvent. The additives (polyethylene wax and alkyl ammonium bentonite) are included in order to stabilize the composition and prevents slumping of the composition when applied to a surface. Another similar composition is disclosed in U.S. Pat. No. 5,587,102 to Stern. The composition described therein includes iron, water, thickener, rust inhibitor, drying agent, surfactant, antimicrobial/antifungal agent, defoamer, and ammonia. This long list of ingredients is considered necessary to provide a magnetically attractive composition having an extended shelf life and which is sufficiently viscous for applying to a substrate.

The need for various additives in a magnetically attractive coating composition is also described in U.S. Pat. Nos. 5,609,788 and 5,843,329, both to Deetz. The composition described therein includes ferromagnetic powder and a surfactant with other optional additives for mixing into a paint. Again, a surfactant is considered required in order to form a stable dispersion of the magnetically attractive powder within the paint.

While coating these compositions allows production of magnetically attractive surfaces, their costs are relatively high compared to conventional coatings (architectural paint) and magnet boards. Accordingly, a need remains for an inexpensive magnetically attractive coating composition which is simple to prepare and includes a minimum number of components.

### SUMMARY OF THE INVENTION

This need is met by the method of making a magnetically attractive coating composition of the present invention. The coating composition of the present invention includes iron particles mixed into a paint composition at a concentration of about 70 to about 85 wt. % to produce a dispersion or mixture. It has been found that when iron particles are added in that concentration range to a typical paint, such as a primer, sealer, or the like, the resultant viscosity is sufficient to maintain the particles dispersed within the mixture for a sufficient time to permit coating a surface therewith. When the mixture is applied to a surface, particularly a vertical surface, it forms uniform coating without slumping. The iron particles may be sized up to about 100 mesh (149 microns) with a portion thereof being finer than 325 mesh (less than 44 microns). The paint may be an oil-based paint or latex paint. The present invention is particularly suited for use with a primer paint. The magnetically attractive coating composition is prepared and applied to a surface and dried. The dried, magnetically attractive surface may then be coated with a decorative coating, such as a colored paint. The strength of the magnetic attraction between the magnetically attractive coating composition applied to a surface and a magnet may be increased by applying multiple coats of the magnetically attractive coated composition to a surface.

### DETAILED DESCRIPTION OF THE INVENTION

The present invention includes methods of making and using a magnetically attractive coating composition. A unique feature of the present invention is the use of a minimum number of components, namely, a conventional paint mixed with iron particles. The iron particles are mixed into the paint to produce a mixture having about 70 to about 85 wt. % iron particles. The iron particles are sized up to about 100 mesh (149 microns) with a portion thereof being finer, such as about 25% being 325 mesh (less than 44 microns). The conventional paint may be an oil-based paint or a latex paint. A particularly suitable paint is a primer paint, such as is used on a wall as a primer before applying a decorative paint.

The magnetically attractive coating composition is prepared by mixing about 7 to about 9 pounds, or about 8 pounds, of iron particles into a gallon of conventional paint. The mixture is stirred until the iron particles are distributed uniformly. The mixture may be applied to a surface by conventional painting techniques. For large areas, such as a 20 square foot area, application with a paint roller is suitable. Acceptable rollers include a 1/4 to 1/2 inch foam roller or a low nap fiber roller. The coating is allowed to dry, and a second coating or multiple additional coatings may be applied to increase the magnetic attractiveness of the final coating composition on the surface. For stronger magnetic attraction, 3 or 4 or more coats may be applied to the surface. In each case, the coating composition is preferably dried completely before an additional coating is applied thereto.

The iron particles generally impart a grayish color to the magnetically attractive coating composition. Primer paint typically has a dull white color; hence, addition of the iron particles thereto does not substantially change the color. Hence, the present invention is particularly suited for use with primer paint which is designed to be covered by a decorative paint or other decorative coatings or coverings, such as wallpaper or fabric. It will be appreciated that thicker decorative coatings or coverings may require multiple layers of the magnetically attractive coating composition thereunder to ensure sufficient magnetic attractiveness. The iron particles are subject to oxidation (rust). The decorative coating or other finish coatings may also be beneficial as a moisture barrier to the iron particles present in the magnetically attractive coating. Due to the iron particles, the magnetically attractive coating has some texture (roughness) when applied to a surface. By covering the magnetically attractive coating with a decorative paint or the like, the roughness of the magnetically attractive coating is smoothed out. The end result is a lightly textured surface that magnetically attracts magnets thereto.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

I claim:

1. A method of making a magnetically attractive coating composition consisting essentially of the steps of:
providing a paint; and
mixing iron particles with the paint to produce a mixture, wherein the concentration of the iron particles in the mixture is about 70 to about 85 wt. %.

2. The method of claim 1, wherein the iron particles are sized up to about 100 mesh.

3. The method of claim 1, wherein the paint is an oil-based paint.

4. The method of claim 1, wherein the paint is a primer paint.

5. A method of making a magnetically attractive surface comprising the steps of:
providing a paint;
mixing iron particles with the paint to produce a mixture, wherein the concentration of the iron particles in the mixture is about 70 to about 85 wt. %; and
applying a coating of the mixture on a substrate.

6. The method of claim 5, wherein the iron particles are sized up to about 100 mesh.

7. The method of claim 5, wherein the paint is an oil-based paint.

8. The method of claim 5, wherein the paint is a primer paint.

9. The method of claim 5 further comprising applying a plurality of coatings of the mixture on the substrate.

10. The method of claim 5 further comprising applying a decorative covering over the coating of the mixture.
